(19) United States
(12) Patent Application Publication
(10) Pub. No.: US 2026/0332205 A1
(43) Pub. Date: Oct. 22, 2026

(54) TRANSMITTER AND METHOD FOR PERFORMING CODEBOOK-BASED BEAMFORMING IN A WIRELESS CHARGING SYSTEM

(71) Applicant: ELECTRONICS AND TELECOMMUNICATIONS RESEARCH INSTITUTE, Daejeon (KR)

(72) Inventors: Jae-Cheol PARK, Daejeon (KR); Jung-Ick MOON, Daejeon (KR); Jae-Hyun PARK, Busan (KR); Ji-Won KIM, Busan (KR); Hui-Jea PARK, Busan (KR); Seung-Su CHUNG, Bussan (KR)

(73) Assignee: ELECTRONICS AND TELECOMMUNICATIONS RESEARCH INSTITUTE, Daejeon (KR)

(21) Appl. No.: 19/578,849

(22) Filed: Mar. 25, 2026

(30) Foreign Application Priority Data
Apr. 21, 2025 (KR) 10-2025-0051436

(51) Int. Cl. H04B 7/06

(52) U.S. Cl. CPC H04B 7/0617; H04B 7/0632; H04B 7/0639

(57) ABSTRACT

Disclosed herein are a transmitter for performing codebook-based beamforming in a wireless charging system and a method therefor. The transmitter may include storage configured to store a plurality of predefined beam indices, a controller configured to select a plurality of candidate beam indices from among the plurality of beam indices based on an azimuth and an elevation, and a power transmitting unit configured to transmit RF signals respectively for the plurality of selected candidate beam indices to a receiver and receive feedback information including RSSI values for the RF signals from the receiver.

### CROSS REFERENCE TO RELATED APPLICATION

This application claims the benefit of Korean Patent Application No. 10-2025-0051436, filed Apr. 21, 2025, which is hereby incorporated by reference in its entirety into this application.

### BACKGROUND OF THE INVENTION

### 1. Technical Field

The present disclosure relates generally to a transmitter for performing codebook-based beamforming in a wireless charging system and a method for the same, and more particularly to a transmitter and method for performing codebook-based beamforming in a wireless charging system in which a wireless charging transmitter supporting codebook-based beamforming detects an optimal beam corresponding to a receiver located at an arbitrary position.

### 2. Description of the Related Art

Beamforming, which is a core technology of 5G mobile communication, may be utilized as a technique for detecting a receiver located at an arbitrary position. Specifically, a transmitter controls beams, measures the received signal quality at the receiver, and then selects a beam that provides optimal signal quality. When a plurality of candidate beams are formed using an array antenna, an optimal beam corresponding to the position of the receiver may be found; however, the large number of candidate beams leads to high computational complexity.

To address this issue, a method for forming beams having different beamwidths to find the position of a receiver in stages has been proposed. [S. Noh, M. D. Zoltowski, and D. J. Love, “Multi-Resolution Codebook and Adaptive Beamforming Sequence Design for Millimeter Wave Beam Alignment,” IEEE Transactions on Wireless Communications, vol. 16, no. 9, pp. 5689-571 September 2017] discloses a technique in which, at each stage, a transmitter transmits multiple beams in non-overlapping directions, collects Received Signal Strength Indicator (RSSI) information as feedback from a receiver, selects a beam having the highest received power among the transmitted beams, and repeats a process of transmitting beams having narrower beamwidths within a region of the selected beam and finding a beam having the highest received power among them. As these stages proceed, the beam may be more precisely steered toward the direction of the receiver; however, when the number of candidate beams is very large, there is a limitation in reducing computational complexity.

### DOCUMENTS OF RELATED ART

(Patent Document 1) KR 10-2020-0122626 A

### SUMMARY OF THE INVENTION

An object of the present disclosure is to provide a transmitter and method for performing codebook-based beamforming in a wireless charging system capable of rapidly detecting the position of a wireless charging receiver using monopulse beamforming for estimating an angle based on a single pulse.

Another object of the present disclosure is to provide a transmitter and method for performing codebook-based beamforming in a wireless charging system in which a monopulse beamforming technique enables accurate angle estimation based on a Difference Sum Ratio (DSR), which is a ratio of a sum beam and a difference beam obtained from a received signal.

A further object of the present disclosure is to provide a transmitter and method for performing codebook-based beamforming in a wireless charging system capable of rapidly detecting an optimal beam corresponding to the position of a wireless charging receiver by applying a monopulse beamforming technique for the wireless charging system that supports codebook-based beamforming.

Yet another object of the present disclosure is to provide a transmitter and method for performing codebook-based beamforming in a wireless charging system in which a wireless charging system supporting codebook-based beamforming is capable of rapidly selecting an optimal beam corresponding to a receiver located at an arbitrary position.

A method for performing codebook-based beamforming in a wireless charging system according to the present disclosure may include selecting a plurality of candidate beam indices within a predefined index range based on an azimuth, transmitting RF signals respectively for the plurality of selected candidate beam indices to a receiver, receiving feedback information including Received Signal Strength Indicator (RSSI) values for the RF signals from the receiver, identifying a first RSSI value and a second RSSI value based on the received feedback information, calculating a Difference Sum Ratio (DSR) value of the candidate beam indices based on the first RSSI value and the second RSSI value, and selecting an optimal beam index in an azimuth direction based on precalculated azimuth reference values and the calculated DSR value.

Identifying the first RSSI value and the second RSSI value may include identifying a largest RSSI value and a second largest RSSI value, among RSSI values of the candidate beam indices, as the first RSSI value and the second RSSI value, respectively, based on the received feedback information.

The method for performing codebook-based beamforming in a wireless charging system may further include determining whether a beam index having the first RSSI value and a beam index having the second RSSI value are adjacent to each other; and when the beam indices are not adjacent, selecting the beam index having the first RSSI value as the optimal beam index in the azimuth direction.

The DSR value may be calculated using an equation below:

$$D S {R}_{x} = \frac{{RSSI}_{max} - {RSSI}_{max - 1}}{{RSSI}_{max} + {RSSI}_{max - 1}}$$

where DSRₓ denotes the DSR value, RSSIₘₐₓ denotes the first RSSI value, and RSSIₘₐₓ₋₁ denotes the second RSSI value.

Selecting the optimal beam index in the azimuth direction may include identifying a plurality of azimuth reference values among the precalculated azimuth reference values based on a beam index having the first RSSI value and a beam index having the second RSSI value and selecting one beam index among the beam index having the first RSSI value, the beam index having the second RSSI value, and beam indices therebetween as the optimal beam index in the azimuth direction based on the calculated DSR value and the plurality of azimuth reference values.

A section between the beam index having the first RSSI value and the beam index having the second RSSI value may be divided into a plurality of regions based on the plurality of azimuth reference values, and selecting the one beam index as the optimal beam index in the azimuth direction may include comparing the calculated DSR value with the plurality of azimuth reference values to identify a region to which the calculated DSR value belongs and selecting a beam index corresponding to the identified region as the optimal beam index in the azimuth direction.

Selecting the optimal beam index in the azimuth direction may include identifying a first azimuth reference value and a second azimuth reference value among the precalculated azimuth reference values based on a beam index having the first RSSI value and a beam index having the second RSSI value and selecting one beam index among the beam index having the first RSSI value, the beam index having the second RSSI value, and beam indices therebetween as the optimal beam index in the azimuth direction based on the calculated DSR value, the first azimuth reference value, and the second azimuth reference value.

A section between the beam index having the first RSSI value and the beam index having the second RSSI value may be divided into three regions based on the first azimuth reference value and the second azimuth reference value, and selecting the one beam index as the optimal beam index in the azimuth direction may include comparing the calculated DSR value with the first azimuth reference value and the second azimuth reference value to identify a region to which the calculated DSR value belongs and selecting a beam index corresponding to the identified region as the optimal beam index in the azimuth direction.

The method for performing codebook-based beamforming in a wireless charging system may further include searching for an optimal beam index in an elevation direction based on the selected optimal beam index in the azimuth direction.

Transmitting the RF signals may include transmitting beam scheduling information to the receiver.

A transmitter for performing codebook-based beamforming in a wireless charging system according to the present disclosure may include storage configured to store a plurality of predefined beam indices, a controller configured to select a plurality of candidate beam indices from among the plurality of beam indices based on an azimuth, and a power transmitting unit configured to transmit RF signals respectively for the plurality of selected candidate beam indices to a receiver and receive feedback information including Received Signal Strength Indicator (RSSI) values for the RF signals from the receiver. The controller may identify a first RSSI value and a second RSSI value based on the received feedback information, calculate a Difference Sum Ratio (DSR) value of the candidate beam indices based on the first RSSI value and the second RSSI value, and select an optimal beam index in an azimuth direction based on precalculated azimuth reference values and the calculated DSR value.

The controller may identify a largest RSSI value and a second largest RSSI value, among RSSI values of the candidate beam indices, as the first RSSI value and the second RSSI value, respectively, based on the received feedback information.

The controller may determine whether a beam index having the first RSSI value and a beam index having the second RSSI value are adjacent to each other, and when the beam indices are not adjacent to each other, the controller may select the beam index having the first RSSI value as the optimal beam index in the azimuth direction.

The DSR value may be calculated using an equation below:

$$D S {R}_{x} = \frac{{RSSI}_{max} - {RSSI}_{max - 1}}{{RSSI}_{max} + {RSSI}_{max - 1}}$$

where DSRₓ denotes the DSR value, RSSIₘₐₓ denotes the first RSSI value, and RSSIₘₐₓ₋₁ denotes the second RSSI value.

The controller may identify a plurality of azimuth reference values among the precalculated azimuth reference values based on a beam index having the first RSSI value and a beam index having the second RSSI value and select one beam index among the beam index having the first RSSI value, the beam index having the second RSSI value, and beam indices therebetween as the optimal beam index in the azimuth direction based on the calculated DSR value and the plurality of azimuth reference values.

A section between the beam index having the first RSSI value and the beam index having the second RSSI value may be divided into a plurality of regions based on the plurality of azimuth reference values, and the controller may compare the calculated DSR value with the plurality of azimuth reference values to identify a region to which the calculated DSR value belongs and may select a beam index corresponding to the identified region as the optimal beam index in the azimuth direction.

The controller may identify a first azimuth reference value and a second azimuth reference value among the precalculated azimuth reference values based on a beam index having the first RSSI value and a beam index having the second RSSI value and select one beam index among the beam index having the first RSSI value, the beam index having the second RSSI value, and beam indices therebetween as the optimal beam index in the azimuth direction based on the calculated DSR value, the first azimuth reference value, and the second azimuth reference value.

A section between the beam index having the first RSSI value and the beam index having the second RSSI value may be divided into three regions based on the first azimuth reference value and the second azimuth reference value, and the controller may compare the calculated DSR value with the first azimuth reference value and the second azimuth reference value to identify a region to which the calculated DSR value belongs and may select a beam index corresponding to the identified region as the optimal beam index in the azimuth direction.

A method for performing codebook-based beamforming in a wireless charging system according to the present disclosure may include selecting a plurality of candidate beam indices within a predefined index range based on an elevation, transmitting RF signals respectively for the plurality of selected candidate beam indices to a receiver, receiving feedback information including Received Signal Strength Indicator (RSSI) values for the RF signals from the receiver, identifying a first RSSI value and a second RSSI value based on the received feedback information, calculating a Difference Sum Ratio (DSR) value of the candidate beam indices based on the first RSSI value and the second RSSI value, and selecting an optimal beam index in an elevation direction based on precalculated elevation reference values and the calculated DSR value.

Selecting the plurality of candidate beam indices within the predefined index range based on the elevation may include selecting the plurality of candidate beam indices from among beam indices associated with an optimal beam index in an azimuth direction within the predefined index range.

Identifying the first RSSI value and the second RSSI value may include identifying a largest RSSI value and a second largest RSSI value, among RSSI values of the candidate beam indices, as the first RSSI value and the second RSSI value, respectively, based on the received feedback information.

The method for performing codebook-based beamforming in a wireless charging system may further include determining whether a beam index having the first RSSI value and a beam index having the second RSSI value are adjacent to each other; and when the beam indices are not adjacent to each other, selecting the beam index having the first RSSI value as the optimal beam index in the elevation direction.

The DSR value may be calculated using an equation below:

$$D S {R}_{y} = \frac{{RSSI}_{max} - {RSSI}_{max - 1}}{{RSSI}_{max} + {RSSI}_{max - 1}}$$

where DSR_{y} denotes the DSR value, RSSIₘₐₓ denotes the first RSSI value, and RSSIₘₐₓ₋₁ denotes the second RSSI value.

Selecting the optimal beam index in the elevation direction may include identifying a plurality of elevation reference values among the precalculated elevation reference values based on a beam index having the first RSSI value and a beam index having the second RSSI value and selecting one beam index among the beam index having the first RSSI value, the beam index having the second RSSI value, and beam indices therebetween as the optimal beam index in the elevation direction based on the calculated DSR value and the plurality of elevation reference values.

A section between the beam index having the first RSSI value and the beam index having the second RSSI value may be divided into a plurality of regions based on the plurality of elevation reference values, and selecting the one beam index as the optimal beam index in the elevation direction may include comparing the calculated DSR value with the plurality of elevation reference values to identify a region to which the calculated DSR value belongs and selecting a beam index corresponding to the identified region as the optimal beam index in the elevation direction.

Selecting the optimal beam index in the elevation direction may include identifying a first elevation reference value and a second elevation reference value among the precalculated elevation reference values based on a beam index having the first RSSI value and a beam index having the second RSSI value and selecting one beam index among the beam index having the first RSSI value, the beam index having the second RSSI value, and beam indices therebetween as the optimal beam index in the elevation direction based on the calculated DSR value, the first elevation reference value, and the second elevation reference value.

A section between the beam index having the first RSSI value and the beam index having the second RSSI value may be divided into three regions based on the first elevation reference value and the second elevation reference value, and selecting the one beam index as the optimal beam index in the elevation direction may include comparing the calculated DSR value with the first elevation reference value and the second elevation reference value to identify a region to which the calculated DSR value belongs and selecting a beam index corresponding to the identified region as the optimal beam index in the elevation direction.

The method for performing codebook-based beamforming in a wireless charging system may further include searching for an optimal beam index in an azimuth direction based on the selected optimal beam index in the elevation direction.

Transmitting the RF signals may include transmitting beam scheduling information to the receiver.

A transmitter for performing codebook-based beamforming in a wireless charging system according to the present disclosure may include storage configured to store a plurality of predefined beam indices, a controller configured to select a plurality of candidate beam indices from among the plurality of beam indices based on an elevation, and a power transmitting unit configured to transmit RF signals respectively for the plurality of selected candidate beam indices to a receiver and receive feedback information including Received Signal Strength Indicator (RSSI) values for the RF signals from the receiver. The controller may identify a first RSSI value and a second RSSI value based on the received feedback information, calculate a Difference Sum Ratio (DSR) value of the candidate beam indices based on the first RSSI value and the second RSSI value, and select an optimal beam index in an elevation direction based on precalculated elevation reference values and the calculated DSR value. Here, the controller may select the plurality of candidate beam indices from among beam indices associated with an optimal beam index in an azimuth direction, among the plurality of beam indices.

The controller may identify a largest RSSI value and a second largest RSSI value, among RSSI values of the candidate beam indices, as the first RSSI value and the second RSSI value, respectively, based on the received feedback information.

The controller may determine whether a beam index having the first RSSI value and a beam index having the second RSSI value are adjacent to each other, and when the beam indices are not adjacent to each other, the controller may select the beam index having the first RSSI value as the optimal beam index in the elevation direction.

The DSR value may be calculated using an equation below:

$$D S {R}_{y} = \frac{{RSSI}_{max} - {RSSI}_{max - 1}}{{RSSI}_{max} + {RSSI}_{max - 1}}$$

where DSR_{y} denotes the DSR value, RSSIₘₐₓ denotes the first RSSI value, and RSSIₘₐₓ₋₁ denotes the second RSSI value.

The controller may identify a plurality of elevation reference values among the precalculated elevation reference values based on a beam index having the first RSSI value and a beam index having the second RSSI value and select one beam index among the beam index having the first RSSI value, the beam index having the second RSSI value, and beam indices therebetween as the optimal beam index in the elevation direction based on the calculated DSR value and the plurality of elevation reference values.

A section between the beam index having the first RSSI value and the beam index having the second RSSI value may be divided into a plurality of regions based on the plurality of elevation reference values, and the controller may compare the calculated DSR value with the plurality of elevation reference values to identify a region to which the calculated DSR value belongs and select a beam index corresponding to the identified region as the optimal beam index in the elevation direction.

The controller may identify a first elevation reference value and a second elevation reference value among the precalculated elevation reference values based on a beam index having the first RSSI value and a beam index having the second RSSI value and select one beam index among the beam index having the first RSSI value, the beam index having the second RSSI value, and beam indices therebetween as the optimal beam index in the elevation direction based on the calculated DSR value, the first elevation reference value, and the second elevation reference value.

A section between the beam index having the first RSSI value and the beam index having the second RSSI value may be divided into three regions based on the first elevation reference value and the second elevation reference value, and the controller may compare the calculated DSR value with the first elevation reference value and the second elevation reference value to identify a region to which the calculated DSR value belongs and may select a beam index corresponding to the identified region as the optimal beam index in the elevation direction.

The power transmitting unit may transmit beam scheduling information to the receiver.

A method for performing codebook-based beamforming in a wireless charging system according to the present disclosure may include calculating an azimuth reference value, calculating an elevation reference value, detecting an optimal beam index in an azimuth direction based on the calculated azimuth reference value, and detecting an optimal beam index in an elevation direction based on the calculated elevation reference value and the detected optimal beam index in the azimuth direction.

The present disclosure may include a computer program stored on a medium readable by a computing device in order to perform a method according to the present disclosure.

The present disclosure may include a non-transitory computer-readable storage medium on which instructions are recorded, the instructions being configured to, when executed by a processor, cause the processor to perform a method according to the present disclosure or operation associated with the method according to the present disclosure.

The present disclosure may include a computer program product including executable instructions for performing a method according to the present disclosure.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram illustrating the configuration of a wireless charging system according to an embodiment of the present disclosure;

FIG. 2 is a view illustrating codebook-based beamforming indices according to an embodiment of the present disclosure;

FIG. 3 is a flowchart illustrating a process for performing a method for performing codebook-based beamforming in a wireless charging system according to an embodiment of the present disclosure;

FIG. 4 is a flowchart illustrating a process for performing a method for detecting an azimuth corresponding to the position of a receiver in a wireless charging system according to an embodiment of the present disclosure;

FIG. 5 is a view for explaining a method for determining an optimal beam index in an azimuth direction;

FIG. 6 is a flowchart illustrating a process of performing a method for detecting an elevation corresponding to the position of a receiver in a wireless charging system according to an embodiment of the present disclosure;

FIG. 7 is a view for explaining a method for determining an optimal beam index in an elevation direction;

FIG. 8 is a flowchart illustrating a process of performing a method for calculating a reference azimuth value in a wireless charging system according to an embodiment of the present disclosure;

FIG. 9 is a graph illustrating a beam pattern and a beam-index-shifted beam pattern for calculating an azimuth reference value;

FIG. 10 is a graph illustrating a DSR value calculated based on the reference beam pattern and the shifted beam pattern in FIG. 9;

FIG. 11 is a flowchart illustrating a process of performing a method for calculating an elevation reference value in a wireless charging system according to an embodiment of the present disclosure;

FIG. 12 is a graph illustrating a beam pattern and a beam-index-shifted beam pattern for calculating an elevation reference value; and

FIG. 13 is a graph illustrating a DSR value calculated based on the reference beam pattern and the shifted beam pattern in FIG. 12.

### DESCRIPTION OF THE PREFERRED EMBODIMENTS

Because the present disclosure may be variously changed and may have various embodiments, specific embodiments will be described in detail below with reference to the attached drawings. However, it should be understood that those embodiments are not intended to limit the present disclosure to specific disclosure forms and that they include all changes, equivalents or modifications included in the spirit and scope of the present disclosure.

Specific embodiments will be described in detail below with reference to the attached drawings. These embodiments are described in sufficient detail to enable those skilled in the art to practice the embodiments. It should be understood that the embodiments differ from each other, but the embodiments do not need to be exclusive of each other. For example, a particular feature, structure, or characteristic described herein in connection with one embodiment may be implemented in another embodiment without departing from the spirit or scope of the present disclosure. Also, it should be understood that the location or arrangement of individual elements in the disclosed embodiments may be changed without departing from the spirit or scope of the embodiments. Therefore, the following detailed description is not to be taken in a limiting sense, and if appropriately interpreted, the scope of the exemplary embodiments is limited only by the appended claims, along with the full range of equivalents to which the claims are entitled.

In the drawings, similar reference numerals are used to designate the same or similar functions in various aspects. The shapes, sizes, etc. of components in the drawings may be exaggerated to make the description clearer. Also, the terms “and/or” may include combinations of a plurality of related described items or any of a plurality of related described items. The terms “part,” “unit,” and “module” as used herein may include one or more components, and may include software components and/or hardware components.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure. Similarly, a second element could also be referred to as a first element.

It will be understood that when a component is referred to as being “connected” or “coupled” to another component, the two components may be directly connected or coupled to each other, or intervening components may be present between the two components. It will be understood that when a component is referred to as being “directly connected or coupled” to another component, no intervening components are present between the two components.

Components in embodiments are independently illustrated in order to indicate different characteristic functions, but this does not mean that each of the components is formed of a separate piece of hardware or software. That is, components are arranged and included for convenience of description, and at least two of the components may form one component, or one component may be divided into multiple components to perform respective functions. An embodiment into which the components are integrated or an embodiment from which some components are separated is included in the scope of the present disclosure, as long as it does not depart from the essence of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. That is, in the embodiments, an expression describing that a component “comprises” a specific component means that additional components may be included within the scope of the practice of the present disclosure or the technical spirit of the present disclosure, but does not preclude the presence of components other than the specific component.

In the embodiments, the term “at least one” may mean one of one or more numbers, such as 1, 2, 3, and 4. In the embodiments, the term “a plurality of” may mean one of two or more numbers, such as 2, 3 and 4.

At least portion of the parts, units, and modules described in the embodiments may be program modules and may communicate with external devices or systems.

The program modules may include a routine, a subroutine, a program, an object, a program component, a data structure, and the like for performing functions or operations according to an embodiment or for implementing abstract data types according to an embodiment, but they are not limited thereto.

Some components of embodiments are not essential components for performing essential functions, but may be optional components for improving only performance. The embodiments may be implemented by including only essential components for implementing the essence of the embodiments, excluding components used only to improve performance. For example, a structure including only essential components, excluding optional components used only to improve performance, is also included in the scope of the embodiments.

Hereinafter, embodiments will be described in detail below with reference to the accompanying drawings so that those having ordinary knowledge in the technical field can easily practice the embodiments. In the following description of the embodiments, detailed descriptions of known functions or configurations which are deemed to obscure the gist of the present specification will be omitted. Further, the same reference numerals are used to designate the same components throughout the drawings, and repeated descriptions of the same components will be omitted.

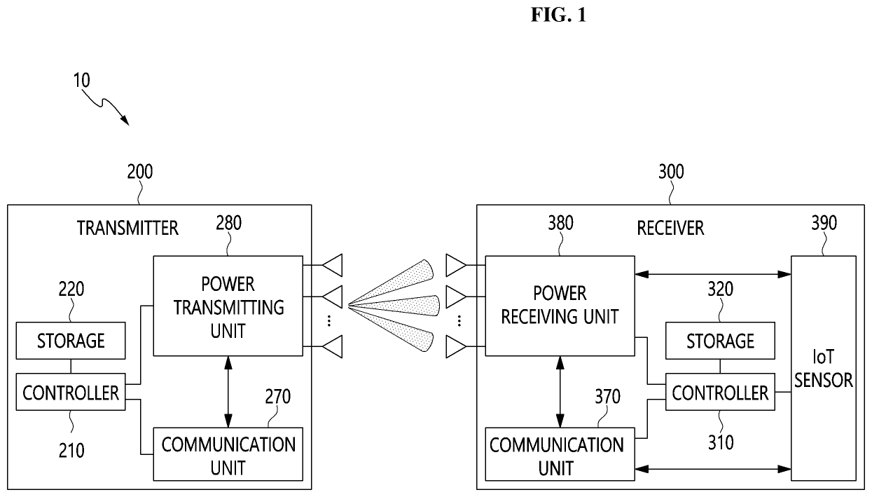

FIG. 1 is a block diagram illustrating the configuration of a wireless charging system according to an embodiment of the present disclosure.

Referring to FIG. 1, the wireless charging system 10 according to the present disclosure may include a transmitter 200 and a receiver 300.

The transmitter 200 may be a wireless charging transmitter configured to wirelessly transmit power to the receiver 300. Although a single receiver 300 is illustrated in FIG. 1, the present disclosure is not limited thereto. The wireless charging system 10 may include a plurality of receivers 300, and the transmitter 200 may wirelessly transmit power to the plurality of receivers 300.

The transmitter 200 may perform an algorithm for selecting an optimal beam corresponding to the receiver 300 at an arbitrary position. The transmitter 200 may sequentially detect the position of the receiver 300 in azimuth and elevation directions using a monopulse beamforming technique. Accordingly, the transmitter 200 according to the present disclosure may reduce computational complexity and processing time by improving an existing beamforming scheme that requires transmitting beams for all beam indices.

The transmitter 200 may perform a function of configuring beams by changing predefined beams based on a codebook and a function of transmitting beam scheduling and feedback information.

The transmitter 200 may include a controller 210, storage 220, a communication unit 270, and a power transmitting unit 280.

The controller 210 may be a semiconductor device for executing processing instructions stored in the storage 220. The controller 210 may be at least one hardware processor. The controller 210 may be configured with one or more cores and may include processors for data analysis and deep learning, such as a Central Processing Unit (CPU), a Graphics Processing Unit (GPU), a Digital Signal Processor (DSP), an Application-Specific Integrated Circuit (ASIC), a General-Purpose Graphics Processing Unit (GPGPU), a Tensor Processing Unit (TPU), and the like.

The controller 210 may read a computer program stored in the storage 220 and perform data processing for a method for detecting an azimuth corresponding to the position of a receiver in a wireless charging system according to an embodiment of the present disclosure.

The controller 210 may control the overall operation of the transmitter 200 and may control the storage 220, the communication unit 270, and the power transmitting unit 280. The controller 210 may execute instructions or code of the parts, units, and modules described in the embodiments.

The storage 220 may be storage media including at least one of a nonvolatile medium, a detachable medium, a non-detachable medium, a communication medium, or an information delivery medium, or a combination thereof. The storage 220 may include ROM or RAM.

The storage 220 may store a plurality of predefined beam indices. The storage 220 may store a codebook including the plurality of predefined beam indices. Also, the storage 220 may store predefined azimuth reference values and elevation reference values.

The communication unit 270 may transmit and receive data to and from the receiver 300 and other electronic devices and servers over a network. The communication unit 270 may include a wireless communication module (e.g., a cellular communication module, a short-range wireless communication module, or a Global Navigation Satellite System (GNSS) communication module) or a wired communication module (e.g., a Local Area Network (LAN) communication module or a powerline communication module). Here, the network may be a private network or the Internet network and may include a wired network or a wireless network. The network may indicate one or more portions of a network that may be an ad-hoc network, an intranet, an extranet, Bluetooth, ZigBee, a Virtual Private Network (VPN), a Local Area Network (LAN), a Wireless LAN (IEEE 802.11b, IEEE 802.11a, IEEE 802.11g, IEEE 802.11n), a Wireless Broadband (WiBro), a Wide Area Network (WAN), a wireless WAN (WWAN), a Metropolitan Area Network (MAN), the Internet, a portion of the Internet, a portion of a Public Switched Telephone Network (PSTN), a Plain Old Telephone Service (POTS) network, a cellular telephone network, a wireless network, a Wi-Fi® network, another type of network, or a combination of two or more of these networks, and may indicate one or more portions of a network connected to another type of network. For example, the network or a portion thereof may include a wireless or cellular network, and the connection may be a Code Division Multiple Access (CDMA) connection, a Global System for Mobile communications (GSM) connection, or another type of cellular or wireless connection. In such an example, the connection may be implemented by any of various types of data transmission technologies, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standards, others technologies defined by various standard establishing organizations, other long-distance protocols, or other data transmission technologies.

The power transmitting unit 280 may transmit signals or power to the receiver 300 or receive signals from the receiver 300. The power transmitting unit 280 may include one or more antennas. The power transmitting unit 280 may select at least one of the plurality of antennas and transmit or receive signals or power to or from the receiver 300 via the selected antenna.

The receiver 300 may receive power from the transmitter 200 for charging and may receive or transmit signals from or to the transmitter 200. The receiver 300 may be a wireless charging receiver.

The receiver 300 may perform functions of receiving RF signals transmitted by the transmitter 200, receiving beam scheduling information, measuring RSSI based thereon, and generating and transmitting feedback information.

The receiver 300 may include a controller 310, storage 320, a communication unit 370, a power receiving unit 380, and an IoT sensor 390.

The controller 310 may be a semiconductor device for executing processing instructions stored in the storage 320. The controller 310 may be at least one hardware processor. The controller 310 may be configured with one or more cores and may include processors for data analysis and deep learning, such as a Central Processing Unit (CPU), a Graphics Processing Unit (GPU), a Digital Signal Processor (DSP), an Application-Specific Integrated Circuit (ASIC), a General-Purpose Graphics Processing Unit (GPGPU), a Tensor Processing Unit (TPU), and the like.

The controller 310 may read a computer program stored in the storage 320 and perform data processing for generating feedback information according to an embodiment of the present disclosure.

The controller 310 may control the overall operation of the receiver 300 and may control the storage 320, the communication unit 370, and the power receiving unit 380. The controller 310 may execute instructions or code of the parts, units, and modules described in the embodiments.

The storage 320 may be storage media including at least one of a nonvolatile medium, a detachable medium, a non-detachable medium, a communication medium, or an information delivery medium, or a combination thereof. The storage 320 may include ROM or RAM.

The communication unit 370 may transmit and receive data to and from the transmitter 200 and other electronic devices and servers over a network. The communication unit 370 may include a wireless communication module (e.g., a cellular communication module, a short-range wireless communication module, or a Global Navigation Satellite System (GNSS) communication module) or a wired communication module (e.g., a Local Area Network (LAN) communication module or a powerline communication module).

The power receiving unit 380 may receive signals or power from the transmitter 200 or transmit signals to the transmitter 200. The power receiving unit 380 may include one or more antennas. The power receiving unit 380 may select at least one of the plurality of antennas. The power receiving unit 380 may receive signals or power from the transmitter 200 and transmit signals thereto via the selected antenna.

The power receiving unit 380 may supply the power received from the transmitter 200 to the IoT sensor 390.

The IoT sensor 390 may operate by being supplied with the power received by the power receiving unit 380. Also, the IoT sensor 390 may be charged using the power.

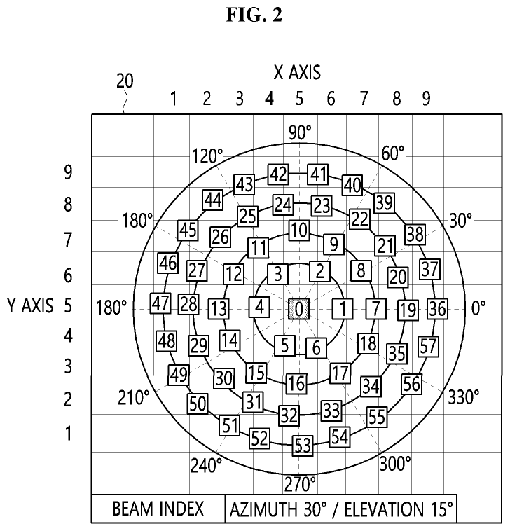

FIG. 2 is a view illustrating beamforming indices based on a codebook according to an embodiment of the present disclosure. FIG. 2 illustrates an example of beam indices that may be configured by a transmitter based on a codebook.

Referring to FIG. 2, the codebook 20 may include a plurality of predefined beam indices. In the codebook 20, 0 to 57 may represent respective beam indices. The storage 220 may store the codebook 20. The storage 220 may store the beam indices from 0 to 57. The index range of the codebook 20 is from 0 to 57.

A beam of the transmitter 200 may be configured within a predefined index range, and the direction of the beam steered by the transmitter 200 may be determined according to a beam index. Based on the codebook 20, the beam of the transmitter 200 may be configured within an index range from 0 to 57.

If the receiver 300 is located on the same line as the transmitter 200, the receiver may receive a signal having the greatest strength for beam index 0, if the receiver 300 is located to the right of the transmitter 200, the receiver may have the greatest received signal strength for beam index 36, if the receiver 300 is located above the transmitter 200, the receiver 300 may have the greatest received signal strength for beam index 41 or 42, and if the receiver 300 is located below the transmitter 200, the receiver 300 may have the greatest received signal strength for beam index 53. Accordingly, the transmitter 200 is required to select an optimal beam index according to the position of the receiver 300, thereby minimizing the loss of transmitted power.

The transmitter 200 may sequentially detect azimuth and elevation directions of the position of the receiver 300.

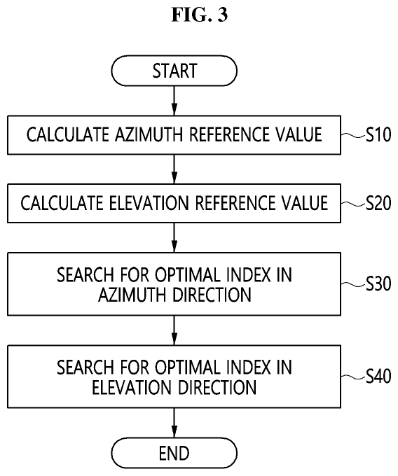

FIG. 3 is a flowchart illustrating a process of performing a method for codebook-based beamforming in a wireless charging system according to an embodiment of the present disclosure.

Referring to FIG. 3, the transmitter 200 calculates azimuth reference values at step S10. The transmitter 200 may store the azimuth reference values calculated at step S10 in the storage 220.

The transmitter 200 calculates elevation reference values at step S20. The transmitter 200 may store the elevation reference values calculated at step S20 in the storage 220.

The transmitter 200 detects an optimal beam index in the azimuth direction corresponding to the position of the receiver 300 at step S30 based on the azimuth reference values calculated at step S10.

The transmitter 200 detects an optimal beam index in the elevation direction corresponding to the position of the receiver 300 at step S40 based on the elevation reference values calculated at step S20 and the optimal beam index in the azimuth direction, which is detected at step S30.

In some embodiments, the transmitter 200 may detect an optimal beam index in the elevation direction corresponding to the position of the receiver 300 at step S30 based on the elevation reference values calculated at step S20, and the transmitter 200 may detect an optimal beam index in the azimuth direction corresponding to the position of the receiver 300 at step S40 based on the azimuth reference values calculated at step S10 and the optimal beam index in the elevation direction, which is detected at step S30.

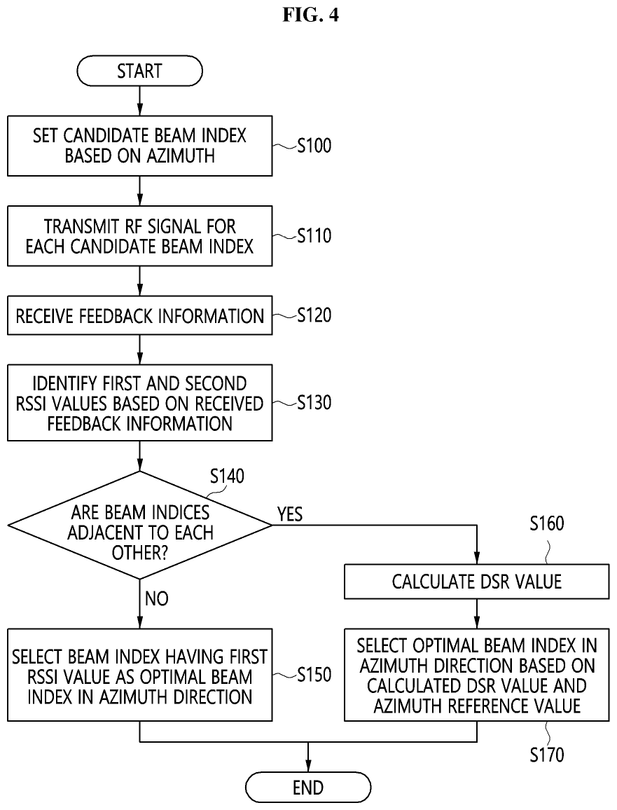

FIG. 4 is a flowchart illustrating a process of performing a method for detecting an azimuth corresponding to the position of a receiver in a wireless charging system according to an embodiment of the present disclosure. FIG. 4 illustrates a procedure for detecting an azimuth corresponding to the position of a receiver.

Referring to FIG. 4, the controller 210 selects a plurality of candidate beam indices within a predefined index range based on an azimuth at step S100. At step S100, the controller 210 may set the candidate beam indices to always include beam indices 47 and 36 among beam indices [47, 28, 13, 4, 0, 1, 7, 19, 36] corresponding to the azimuth based on the beam indices of the codebook 20. The candidate beam indices may be X1=[47, 13, 0, 7, 36], X2=[47, 4, 7, 36], or X3=[47, 0, 36].

The power transmitting unit 280 transmits RF signals respectively for the plurality of selected candidate beam indices to the receiver 300 at step S110. At step S110, the power transmitting unit 280 may further transmit beam scheduling information to the receiver 300. In some embodiments, the beam scheduling information may include the beam indices included in the codebook 20. In some embodiments, the beam scheduling information may include the candidate beam indices selected at step S100. When the controller 210 selects the candidate beam index set X1 at step S100, the transmitter 200 may sequentially set the beam index to 47, 13, 0, 7, and 36 to transmit RF signals and may transmit the beam scheduling information to the receiver 300. In some embodiments, the beam scheduling information may be transmitted to the receiver 300 by the communication unit 270 at step S110. The receiver 300 may collect Received Signal Strength Indicator (RSSI) information for the RF signals transmitted at step S110, generate feedback information including the collected RSSI information, and transmit the feedback information to the transmitter 200. Here, the collected RSSI information may include RSSI values.

The power receiving unit 380 receives the feedback information including the RSSI values for the RF signals transmitted at step S110 from the receiver 300 at step S120. In some embodiments, the communication unit 270 may receive the feedback information at step S120.

The controller 210 identifies a first RSSI value and a second RSSI value at step S130 based on the feedback information received at step S120. At step S130, the controller 210 may identify a largest RSSI value and a second largest RSSI value, among RSSI values of the candidate beam indices, as the first RSSI value and the second RSSI value, respectively, based on the feedback information received at step S120. That is, the controller 210 may identify beam indices corresponding to the largest RSSI value (first RSSI value) and the second largest RSSI value (second RSSI value) collected by the receiver 300 based on the feedback information.

The controller 210 checks whether the beam index having the first RSSI value and the beam index having the second RSSI value, which are identified at step S130, are adjacent to each other at step S140. Here, the controller 210 may determine that the beam indices are adjacent to each other when no more than two beam indices are present therebetween, and may determine that the beam indices are not adjacent to each other when more than two beam indices are present therebetween. For example, when it is determined at step S140 that beam indices having the first and second RSSI values identified at step S130 are adjacent to each other, such as beam indices [47, 13] (with no more than two beam indices therebetween), the controller 210 determines that the measurement result is valid, and it may search for an optimal beam index between the adjacent beam indices. However, when the beam indices are not adjacent to each other, such as beam indices [47, 0] (with three beam indices therebetween), the controller 210 determines that the measurement result is not valid, and it may select the beam index having the largest RSSI value for the optimal beam.

When the beam index having the first RSSI value and the beam index having the second RSSI value are not adjacent to each other, the controller 210 selects the beam index having the first RSSI value as the optimal beam index in the azimuth direction at step S150.

When the beam index having the first RSSI value and the beam index having the second RSSI value are adjacent to each other, the controller 210 calculates a Difference Sum Ratio (DSR) value of the candidate beam indices based on the first and second RSSI values at step S160. At step S160, the controller 210 may calculate the DSR of the first and second RSSI values.

At step S160, the DSR value may be calculated using Equation (1) below:

$$D S {R}_{x} = \frac{{RSSI}_{max} - {RSSI}_{max - 1}}{{RSSI}_{max} + {RSSI}_{max - 1}} \qquad ( 1 )$$

Here, DSRₓ denotes the DSR value, and RSSIₘₐₓ and RSSIₘₐₓ₋₁ denote the first RSSI value and the second RSSI value, respectively.

The controller 210 selects the optimal beam index in the azimuth direction at step S170 based on precalculated azimuth reference values and the calculated DSR value. At step S170, the controller 210 may identify a plurality of azimuth reference values, among the precalculated azimuth reference values, based on the beam index having the first RSSI value and the beam index having the second RSSI value, and may select one beam index among the beam index having the first RSSI value, the beam index having the second RSSI value, and beam indices therebetween as the optimal beam index in the azimuth direction based on the calculated DSR value and the plurality of azimuth reference values. Here, the precalculated azimuth reference values may be the azimuth reference values calculated at step S10. Also, the plurality of azimuth reference values are reference values for dividing the section between the beam index having the first RSSI value and the beam index having the second RSSI value into a plurality of regions. The controller 210 may compare the calculated DSR value with the plurality of azimuth reference values to identify the region to which the calculated DSR value belongs, and may select the beam index corresponding to the identified region as the optimal beam index in the azimuth direction.

In some embodiments, at step S170, the controller 210 may identify a first azimuth reference value and a second azimuth reference value, among the precalculated azimuth reference values, based on the beam index having the first RSSI value and the beam index having the second RSSI value, and may select one beam index among the beam index having the first RSSI value, the beam index having the second RSSI value, and beam indices therebetween as the optimal beam index in the azimuth direction based on the calculated DSR value, the first azimuth reference value, and the second azimuth reference value. Here, the precalculated azimuth reference values may be the azimuth reference values calculated at step S10. Also, the first azimuth reference value and the second azimuth reference value are a first reference value and a second reference value for dividing the section between the beam index having the first RSSI value and the beam index having the second RSSI value into three regions. The controller 210 may compare the calculated DSR value with the first azimuth reference value and the second azimuth reference value to identify the region to which the calculated DSR value belongs, and may select the beam index corresponding to the identified region as the optimal beam index in the azimuth direction.

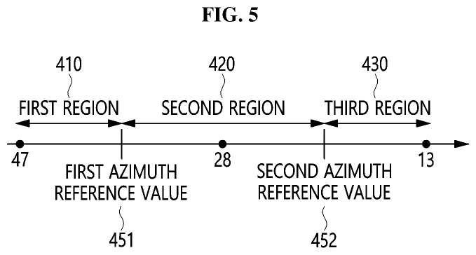

FIG. 5 is a view for explaining a method for determining an optimal beam index in the azimuth direction. FIG. 5 illustrates a procedure for searching for an optimal beam based on an azimuth when a measurement result is determined to be valid.

Referring to FIG. 5, the controller 210 may compare the DSR calculated at step S160 with the azimuth reference values calculated at step S10 and select the beam index of the corresponding region as the optimal beam index at step S170. The controller 210 may load the azimuth reference values calculated at step S10 from the storage 220 based on an interval between beam indices in the codebook20. For example, when beam indices [47, 13] are selected, the controller 210 may access a first azimuth reference value 451 and a second azimuth reference value 452, which are two azimuth reference values for determining an optimal beam index among [47, 28, 13], from the storage 220. When the DSR value calculated at step S160 belongs to a first region 410, 47 may be selected as the optimal beam index in the azimuth direction, when the DSR value belongs to a second region 420, 28 may be selected as the optimal beam index in the azimuth direction, and when the DSR value belongs to a third region 430, 13 may be selected as the optimal beam index in the azimuth direction. The controller 210 may store the X-axis value corresponding to the selected beam index in the storage 220. Here, the controller 210 may determine the azimuth reference value according to a beam pattern.

Step S30 may include steps S100 to S170 illustrated in FIG. 4.

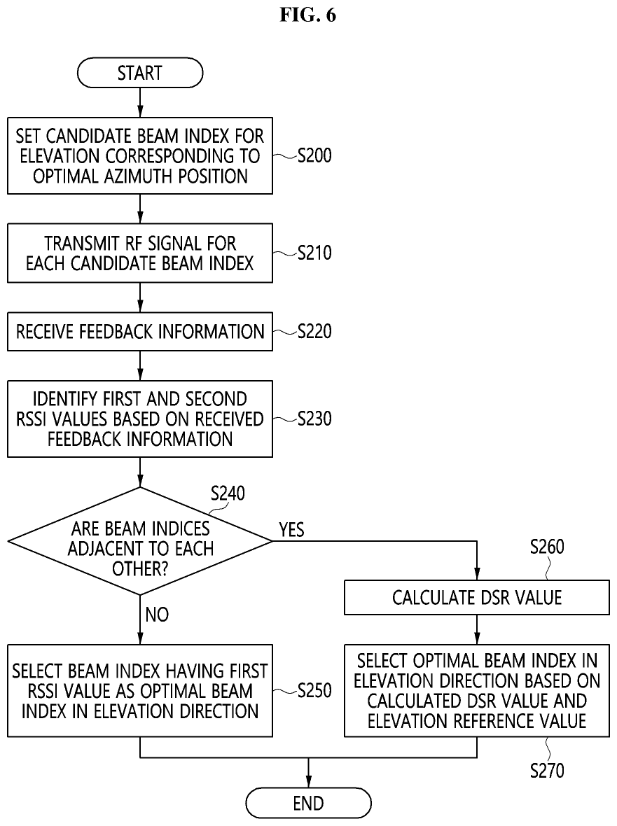

FIG. 6 is a flowchart illustrating a process of performing a method for detecting an elevation corresponding to the position of a receiver in a wireless charging system according to an embodiment of the present disclosure. FIG. 6 illustrates a procedure for detecting an elevation corresponding to the position of a receiver.

Referring to FIG. 6, the controller 210 selects a plurality of candidate beam indices within a predefined index range based on an elevation at step S200. At step S200, the controller 210 may select a plurality of beam indices based on the elevation corresponding to an azimuth associated with the beam index selected at step S170. That is, the controller 210 may select beam indices in order to detect an elevation based on the azimuth corresponding to the position of the receiver 300. Here, in the elevation direction, the candidate beam indices may be selected from among beam indices corresponding to the X-axis, which are stored in the storage 220 at step S170. For example, when the optimal beam index in the azimuth direction is determined to be 0 at step S170, the controller 210 may select a plurality of candidate beam indices from among beam indices [42, 24, 10, 3, 0, 5, 16, 32, 53] in the elevation direction based on beam index 0 determined from the codebook 20 at step S200. Here, for beam indices [42, 24, 10, 3, 0, 5, 16, 32, 53], the controller 210 may configure the candidate beam indices to always include beam indices 42 and 53. The candidate beam indices may be Y1=[42, 10, 0, 16, 53], Y2=[42, 3, 16, 53], or Y3=[42, 0, 53].

The power transmitting unit 280 transmits RF signals respectively for the plurality of selected candidate beam indices to the receiver 300 at step S210. At step S210, the power transmitting unit 280 may further transmit beam scheduling information to the receiver 300. In some embodiments, the beam scheduling information may include the beam indices included in the codebook 20. In some embodiments, the beam scheduling information may include the candidate beam indices selected at step S200.

At step S200, when the controller 210 selects the candidate beam index set Y1, the transmitter 200 may sequentially set the beam index to 42, 10, 0, 16, and 53 to transmit RF signals and may transmit the beam scheduling information to the receiver 300. In some embodiments, the beam scheduling information may be transmitted to the receiver 300 by the communication unit 270 at step S210. The receiver 300 may collect RSSI information for the RF signals transmitted at step S210, generate feedback information including the collected RSSI information, and transmit the feedback information to the transmitter 200. Here, the collected RSSI information may include RSSI values.

The power receiving unit 380 receives the feedback information including the RSSI values for the RF signals transmitted at step S210 from the receiver 300 at step S220. In some embodiments, the communication unit 270 may receive the feedback information at step S220.

The controller 210 identifies a first RSSI value and a second RSSI value at step S230 based on the feedback information received at step S220. At step S230, the controller 210 may identify a largest RSSI value and a second largest RSSI value, among RSSI values of the candidate beam indices, as the first RSSI value and the second RSSI value, respectively, based on the feedback information received at step S220. That is, the controller 210 may identify beam indices corresponding to the largest RSSI value (first RSSI value) and the second largest RSSI value (second RSSI value) collected by the receiver 300 based on the feedback information.

The controller 210 determines whether the beam index having the first RSSI value and the beam index having the second RSSI value, which are identified at step S230, are adjacent to each other at step S240. Here, the controller 210 may determine that the beam indices are adjacent to each other when no more than two beam indices are present therebetween, and may determine that the beam indices are not adjacent to each other when more than two beam indices are present therebetween. For example, when the beam indices having the first and second RSSI values identified at step S230 are adjacent to each other, such as beam indices [42, 3] (with two beam indices therebetween), the controller 210 determines that the measurement result is valid, and it may search for the optimal beam index between the adjacent beam indices. However, when the beam indices are not adjacent to each other, such as beam indices [42, 16] (with five beam indices therebetween), the controller 210 determines that the measurement result is not valid, and it may select the beam index having the largest RSSI value for the optimal beam.

When the beam index having the first RSSI value and the beam index having the second RSSI value are not adjacent to each other, the controller 210 selects the beam index having the first RSSI value as the optimal beam index in the elevation direction at step S250.

When the beam index having the first RSSI value and the beam index having the second RSSI value are adjacent to each other, the controller 210 calculates a Difference Sum Ratio (DSR) value of the candidate beam indices based on the first RSSI value and the second RSSI value at step S260. At step S260, the controller 210 may calculate the DSR of the first RSSI value and the second RSSI value.

At step S260, the DSR value may be calculated using Equation (2) below:

$$D S {R}_{y} = \frac{{RSSI}_{max} - {RSSI}_{max - 1}}{{RSSI}_{max} + {RSSI}_{max - 1}} \qquad ( 2 )$$

Here, DSR_{y} denotes the DSR value, and RSSIₘₐₓ and RSSIₘₐₓ₋₁ denote the first RSSI value and the second RSSI value, respectively.

The controller 210 selects the optimal beam index in the elevation direction based on precalculated elevation reference values and the calculated DSR value at step S270. At step S270, the controller 210 may identify a plurality of elevation reference values, among the precalculated elevation reference values, based on the beam index having the first RSSI value and the beam index having the second RSSI value, and may select one beam index among the beam index having the first RSSI value, the beam index having the second RSSI value, and beam indices therebetween as the optimal beam index in the elevation direction based on the calculated DSR value and the plurality of elevation reference values. Here, the precalculated elevation reference values may be the elevation reference values calculated at step S20. Also, the plurality of elevation reference values are reference values for dividing the section between the beam index having the first RSSI value and the beam index having the second RSSI value into a plurality of regions. The controller 210 may compare the calculated DSR value with the plurality of elevation reference values to identify the region to which the calculated DSR value belongs, and may select the beam index corresponding to the identified region as the optimal beam index in the elevation direction.

In some embodiments, at step S270, the controller 210 may identify a first elevation reference value and a second elevation reference value, among the precalculated elevation reference values, based on the beam index having the first RSSI value and the beam index having the second RSSI value, and may select one beam index among the beam index having the first RSSI value, the beam index having the second RSSI value, and beam indices therebetween as the optimal beam index in the elevation direction based on the calculated DSR value, the first elevation reference value, and the second elevation reference value. Here, the precalculated elevation reference values may be the elevation reference values calculated at step S20. Also, the first elevation reference value and the second elevation reference value are a first reference value and a second reference value for dividing the section between the beam index having the first RSSI value and the beam index having the second RSSI value into three regions. The controller 210 may compare the calculated DSR value with the first elevation reference value and the second elevation reference value to identify the region to which the calculated DSR value belongs, and may select the beam index corresponding to the identified region as the optimal beam index in the elevation direction.

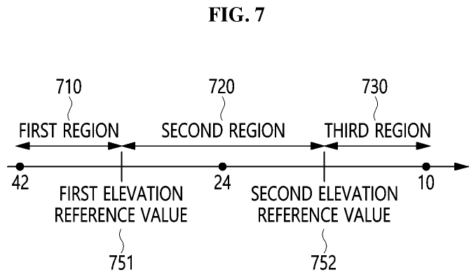

FIG. 7 is a view for explaining a method for determining an optimal beam index in the elevation direction. FIG. 7 illustrates a procedure for searching for an optimal beam based on an elevation when a measurement result is determined to be valid.

Referring to FIG. 7, the controller 210 may compare the DSR calculated at step S260 with the elevation reference values calculated at step S20 and select the beam index of the corresponding region as the optimal beam index at step S270. The controller 210 may load the elevation reference values calculated at step S20 from the storage 220 based on an interval between beam indices in the codebook 20. For example, when beam indices [42, 10] are selected at step S230, the controller 210 may access a first elevation reference value 751 and a second elevation reference value 752, which are two elevation reference values for determining an optimal beam index among [42, 24, 10], from the storage 220. When the DSR value calculated at step S260 belongs to a first region 710, 42 may be selected as the optimal beam index in the elevation direction, when the DSR value belongs to a second region 720, 24 may be selected as the optimal beam index in the elevation direction, and when the DSR value belongs to a third region 730, 10 may be selected as the optimal beam index in the elevation direction. The controller 210 may store the Y-axis value corresponding to the selected beam index in the storage 220. Here, the controller 210 may determine the elevation reference value according to a beam pattern.

Step S40 may include steps S200 to S270 illustrated in FIG. 6. In an embodiment in which step S30 is performed after step S40, the controller 210 may select a plurality of candidate beam indices at step S100 based on the azimuth corresponding to the elevation associated with the beam index selected at step S270. That is, the controller 210 may select beam indices in order to detect an azimuth based on the elevation corresponding to the position of the receiver 300. Here, in the azimuth direction, the candidate beam indices may be selected from among the beam indices corresponding to the Y-axis, which are stored in the storage 220 at step S270.

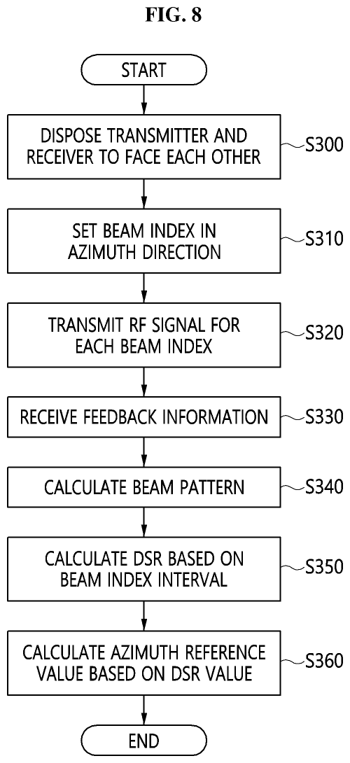

FIG. 8 is a flowchart illustrating a process of performing a method for calculating an azimuth reference value in a wireless charging system according to an embodiment of the present disclosure. FIG. 8 illustrates a method for calculating a reference value required for determining an optimal beam index in the azimuth direction.

Referring to FIG. 8, the transmitter 200 and the receiver 300 are disposed to face each other at step S300.

The transmitter 200 sets beam indices in the azimuth direction at step S310. For example, the beam indices may be set at step S310 by sequentially changing the beam index of the transmitter 200 to beam indices [47, 28, 13, 4, 0, 1, 7, 19, 36] of the codebook 20.

The transmitter 200 transmits RF signals for the respective beam indices set at step S310 to the receiver 300 at step S320.

The transmitter 200 receives feedback information including RSSI values for the RF signals transmitted at step S320 from the receiver 300 at step S330. The transmitter 200 may store the RSSI values included in the feedback information in the storage 220.

At step S340, the transmitter 200 calculates a beam pattern based on the feedback information received at step S330. At step S340, the transmitter 200 may calculate a reference beam pattern based on the RSSI values included in the feedback information received at step S330. At step S340, a shifted beam pattern may be calculated by shifting the beam index to the right by a beam index interval based on the reference beam pattern. Here, the beam index interval may range from 1 to 4.

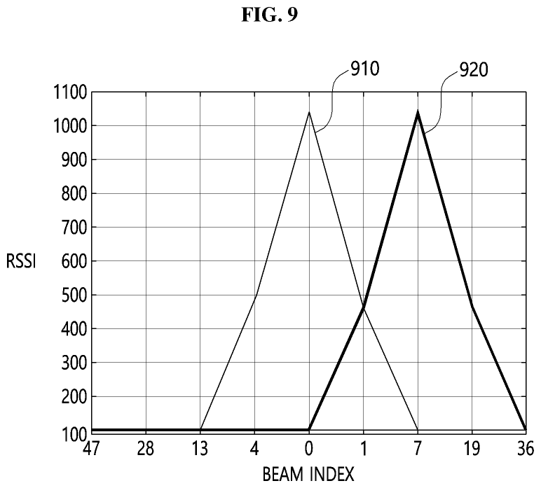

FIG. 9 is a graph illustrating a beam pattern and a beam-index-shifted beam pattern for calculating an azimuth reference value.

Referring to FIG. 9, for example, in order to obtain an azimuth reference value for beam indices [47, 13, 0, 7, 36] configured at an interval of two, a reference beam pattern 910 and a beam pattern 920 shifted by two beam indices to the right may be calculated at step S340, as shown in FIG. 9.

The transmitter 200 calculates a DSR according to the beam index interval at step S350. At step S350, the transmitter 200 may calculate a DSR value for the RSSI value of the reference beam pattern and the RSSI value of the corresponding shifted beam pattern calculated at step S340.

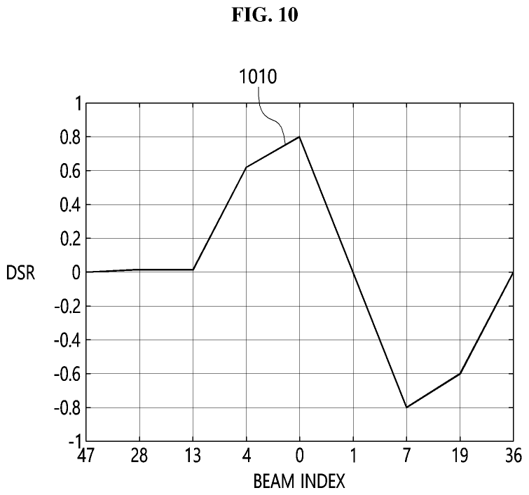

FIG. 10 is a graph illustrating a DSR value calculated based on the reference beam pattern and shifted beam pattern of FIG. 9.

Referring to FIG. 10, for example, when the DSR value for the RSSI value of the reference beam pattern 910 and the RSSI value of the corresponding shifted beam pattern 920 is calculated at step S350, the DSR value 1010 based on the beam indices may be calculated.

The transmitter 200 calculates azimuth reference values based on the DSR value at step S360. For example, at step S360, the range of the valid DSR value corresponds to beam indices [0, 1, 7] in FIG. 10, and the azimuth reference values for separating the DSR value into three regions are set using this value. If the DSR values are [+0.8, 0, −0.8], the azimuth reference values may become 0.4 (=(0.8+0)/2) and −0.4 (=(0−0.8)/2) by calculating the median value of the DSR values of the adjacent beam indices. In the same manner, a shifted beam pattern is calculated by shifting the beam index by an interval of 3 or 4 based on the reference beam pattern at step S340, the DSR values are calculated at step S350, and the median value of the DSR values of the adjacent beam indices is calculated at step S360, whereby the azimuth reference values based on the beam index interval may be calculated.

Step S10 may include steps S300 to S360 illustrated in FIG. 8.

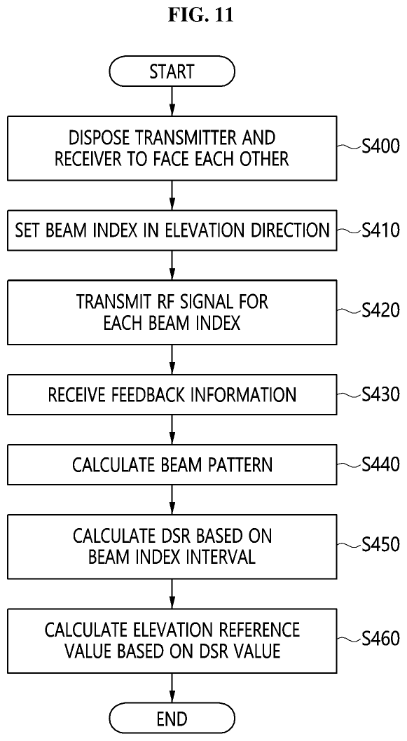

FIG. 11 is a flowchart illustrating a process of performing a method for calculating an elevation reference value in a wireless charging system according to an embodiment of the present disclosure.

Referring to FIG. 11, the transmitter 200 and the receiver 300 are disposed to face each other at step S400.

The transmitter 200 sets beam indices in the elevation direction at step S410. For example, the beam indices may be set at step S410 by sequentially changing the beam index of the transmitter 200 to beam indices [42, 24, 10, 3, 0, 5, 16, 32, 53] of the codebook 20.

The transmitter 200 transmits RF signals for the respective beam indices set at step S410 to the receiver 300 at step S420.

The transmitter 200 receives feedback information including RSSI values for the RF signals transmitted at step S420 from the receiver 300 at step S430. The transmitter 200 may store the RSSI values included in the feedback information in the storage 220.

At step S440, the transmitter 200 calculates a beam pattern based on the feedback information received at step S430. At step S440, the transmitter 200 may calculate a reference beam pattern based on the RSSI values included in the feedback information received at step S430. At step S440, a shifted beam pattern may be calculated by shifting the beam index to the right by a beam index interval based on the reference beam pattern. Here, the beam index interval may range from 1 to 4.

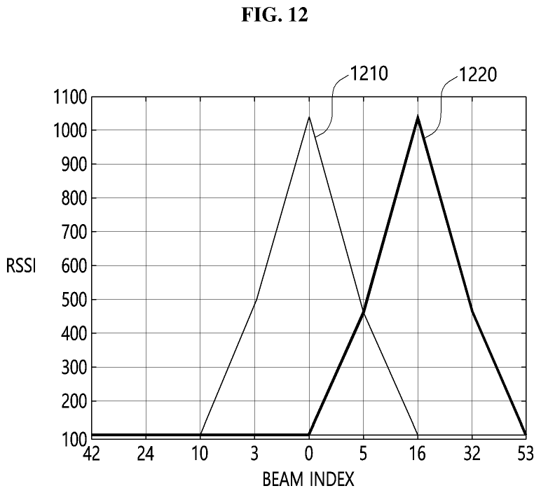

FIG. 12 is a graph illustrating a beam pattern and a beam-index-shifted beam pattern for calculating an elevation reference value.

Referring to FIG. 12, for example, in order to obtain an elevation reference value for beam indices [42, 10, 0, 16, 53] configured at an interval of two, a reference beam pattern 1210 and a beam pattern 1220 shifted by two beam indices to the right may be calculated at step S440, as shown in FIG. 12.

The transmitter 200 calculates a DSR according to the beam index interval at step S450. At step S450, the transmitter 200 may calculate a DSR value for the RSSI value of the reference beam pattern and the RSSI value of the corresponding shifted beam pattern calculated at step S440.

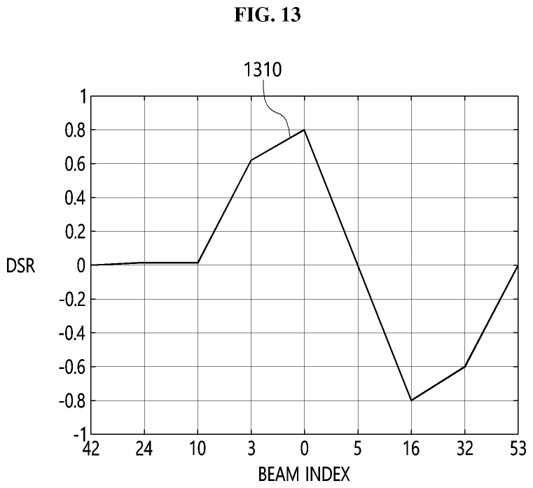

FIG. 13 is a graph illustrating a DSR value calculated based on the reference beam pattern and shifted beam pattern of FIG. 12.

Referring to FIG. 13, for example, when the DSR value for the RSSI value of the reference beam pattern 1210 and the RSSI value of the corresponding shifted beam pattern 1220 is calculated at step S450, the DSR value 1310 based on the beam indices may be calculated.

The transmitter 200 calculates elevation reference values based on the DSR value at step S460. For example, at step S460, the range of the valid DSR value corresponds to beam indices [0, 5, 16] in FIG. 13, and the elevation reference values for separating the DSR value into three regions are set using this value. If the DSR value is [+0.8, 0, −0.8], the elevation reference values may become 0.4 (=(0.8+0)/2) and −0.4 (=(0−0.8)/2) by calculating the median value of the DSR values of the adjacent beam indices. In the same manner, a shifted beam pattern is calculated by shifting the beam index by an interval of 3 or 4 based on the reference beam pattern at step S440, the DSR values are calculated at step S450, and the median value of the DSR values of the adjacent beam indices is calculated at step S460, whereby the elevation reference value based on the beam index interval may be calculated.

Step S20 may include steps S400 to S460 illustrated in FIG. 11.

In the above-described embodiments, it may be construed that, when specified processing is applied to a specified target, specified conditions may be required. Also, it may be construed that, when a description is made such that the specified processing is performed under a specified decision, whether the specified conditions are satisfied may be determined based on a specified coding parameter and that, alternatively, when a description is made such that a specified decision is made based on a specified coding parameter, the specified coding parameter may be replaced with an additional coding parameter. In other words, it may be considered that a coding parameter that influences the specified condition or the specified decision is merely exemplary, and it may be understood that, in addition to the specified coding parameter, a combination of one or more other coding parameters may function as the specified coding parameter.

In the above-described embodiments, although the methods have been described based on flowcharts as a series of steps or units, the present disclosure is not limited to the sequence of the steps and some steps may be performed in a sequence different from that of the described steps or simultaneously with other steps. Further, those skilled in the art will understand that the steps shown in the flowchart are not exclusive and may further include other steps, or that one or more steps in the flowchart may be deleted without departing from the scope of the present disclosure.

The above-described embodiments include various aspects of examples. Although not all possible combinations for indicating various aspects can be described, those skilled in the art will recognize that additional combinations other than the explicitly described combinations are possible. Therefore, it may be appreciated that the present disclosure includes all other replacements, changes, and modifications belonging to the accompanying claims.

The above-described embodiments according to the present disclosure may be implemented as program instructions that can be executed by various computer components and may be recorded on a computer-readable storage medium. The computer-readable storage medium may include program instructions, data files, and data structures, either solely or in combination. Program instructions recorded on the computer-readable storage medium may have been specially designed and configured for the present disclosure, or may be known to or available to those who have ordinary knowledge in the field of computer software.

The computer-readable storage medium may include information used in embodiments according to the present disclosure. For example, the computer-readable storage medium may include a bitstream, which may include information described in the embodiments according to the present disclosure.

The bitstream may include computer-executable code and/or a program. The computer-executable code and/or program may include pieces of information described in the embodiments and syntax elements described in the embodiments. That is, the pieces of information and syntax elements described in the embodiments may be regarded as computer-executable code within the bitstream, and may be regarded as at least part of the computer-executable code and/or program represented as a bitstream.

The computer-readable storage medium may include a non-transitory computer-readable medium.

Examples of the computer-readable storage medium include all types of hardware devices specially configured to record and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present disclosure, and vice versa.

A transmitter and method for performing codebook-based beamforming in a wireless charging system according to the present disclosure enable accurate and rapid detection and tracking of a receiver for wireless charging using millimeter waves, and in particular, there is a possibility of extending a charging distance and improving power transmission efficiency in a wireless power transmission system.

As described above, although the present disclosure has been described based on specific details such as detailed components and a limited number of embodiments and drawings, the embodiments are merely provided for easy understanding of the entire disclosure, the present disclosure is not limited thereto, and those skilled in the art will practice various changes and modifications from the above description.

Accordingly, the spirit of the present disclosure should not be construed as being limited to the above-described embodiments, and the entire scope of the appended claims and their equivalents should be understood as defining the scope and spirit of the present disclosure.

What is claimed is:

1. A method for performing codebook-based beamforming in a wireless charging system, comprising:
selecting a plurality of candidate beam indices within a predefined index range based on an azimuth;
transmitting RF signals respectively corresponding to the plurality of selected candidate beam indices to a receiver;
receiving feedback information including Received Signal Strength Indicator (RSSI) values for the RF signals from the receiver;
identifying a first RSSI value and a second RSSI value based on the received feedback information;
calculating a Difference Sum Ratio (DSR) value of the candidate beam indices based on the first RSSI value and the second RSSI value; and
selecting an optimal beam index in an azimuth direction based on precalculated azimuth reference values and the calculated DSR value.

2. The method of claim 1, wherein identifying the first RSSI value and the second RSSI value comprises identifying a largest RSSI value and a second largest RSSI value, among RSSI values of the candidate beam indices, as the first RSSI value and the second RSSI value, respectively, based on the received feedback information.

3. The method of claim 2, further comprising:
determining whether a beam index having the first RSSI value and a beam index having the second RSSI value are adjacent to each other; and
selecting the beam index having the first RSSI value as the optimal beam index in the azimuth direction when the beam indices are not adjacent to each other.

4. The method of claim 1, wherein the DSR value is calculated using an equation below:
$$D S {R}_{x} = \frac{{RSSI}_{max} - {RSSI}_{max - 1}}{{RSSI}_{max} + {RSSI}_{max - 1}}$$
where DSRₓ denotes the DSR value, RSSIₘₐₓ denotes the first RSSI value, and RSSIₘₐₓ₋₁ denotes the second RSSI value.

5. The method of claim 1, wherein selecting the optimal beam index in the azimuth direction comprises
identifying a plurality of azimuth reference values among the precalculated azimuth reference values based on a beam index having the first RSSI value and a beam index having the second RSSI value; and
selecting one beam index among the beam index having the first RSSI value, the beam index having the second RSSI value, and beam indices therebetween as the optimal beam index in the azimuth direction based on the calculated DSR value and the plurality of azimuth reference values.

6. The method of claim 5, wherein:
a section between the beam index having the first RSSI value and the beam index having the second RSSI value is divided into a plurality of regions based on the plurality of azimuth reference values, and
selecting the one beam index as the optimal beam index in the azimuth direction comprises comparing the calculated DSR value with the plurality of azimuth reference values to identify a region to which the calculated DSR value belongs and selecting a beam index corresponding to the identified region as the optimal beam index in the azimuth direction.

7. The method of claim 1, wherein selecting the optimal beam index in the azimuth direction comprises
identifying a first azimuth reference value and a second azimuth reference value among the precalculated azimuth reference values based on a beam index having the first RSSI value and a beam index having the second RSSI value; and
selecting one beam index among the beam index having the first RSSI value, the beam index having the second RSSI value, and beam indices therebetween as the optimal beam index in the azimuth direction based on the calculated DSR value, the first azimuth reference value, and the second azimuth reference value.

8. The method of claim 7, wherein
a section between the beam index having the first RSSI value and the beam index having the second RSSI value is divided into three regions based on the first azimuth reference value and the second azimuth reference value, and
selecting the one beam index as the optimal beam index in the azimuth direction comprises comparing the calculated DSR value with the first azimuth reference value and the second azimuth reference value to identify a region to which the calculated DSR value belongs and selecting a beam index corresponding to the identified region as the optimal beam index in the azimuth direction.

9. The method of claim 1, further comprising:
searching for an optimal beam index in an elevation direction based on the selected optimal beam index in the azimuth direction.

10. The method of claim 1, wherein transmitting the RF signals comprises transmitting beam scheduling information to the receiver.

11. A transmitter for performing codebook-based beamforming in a wireless charging system, comprising:
a storage configured to store a plurality of predefined beam indices;
a controller configured to select a plurality of candidate beam indices from among the plurality of beam indices based on an elevation; and
a power transmitting unit configured to transmit RF signals respectively for the plurality of selected candidate beam indices to a receiver and receive feedback information including Received Signal Strength Indicator (RSSI) values for the RF signals from the receiver,
wherein the controller identifies a first RSSI value and a second RSSI value based on the received feedback information, calculates a Difference Sum Ratio (DSR) value of the candidate beam indices based on the first RSSI value and the second RSSI value, and selects an optimal beam index in an elevation direction based on precalculated elevation reference values and the calculated DSR value.

12. The transmitter of claim 11, wherein the controller identifies a largest RSSI value and a second largest RSSI value, among RSSI values of the candidate beam indices, as the first RSSI value and the second RSSI value based on the received feedback information.

13. The transmitter of claim 12, wherein the controller determines whether a beam index having the first RSSI value and a beam index having the second RSSI value are adjacent to each other, and when the beam indices are not adjacent to each other, the controller selects the beam index having the first RSSI value as the optimal beam index in the elevation direction.

14. The transmitter of claim 11, wherein the DSR value is calculated using an equation below:
$$D S {R}_{y} = \frac{{RSSI}_{max} - {RSSI}_{max - 1}}{{RSSI}_{max} + {RSSI}_{max - 1}}$$
where DSR_{y} denotes the DSR value, RSSIₘₐₓ denotes the first RSSI value, and RSSIₘₐₓ₋₁ denotes the second RSSI value.

15. The transmitter of claim 11, wherein the controller identifies a plurality of elevation reference values among the precalculated elevation reference values based on a beam index having the first RSSI value and a beam index having the second RSSI value and selects one beam index among the beam index having the first RSSI value, the beam index having the second RSSI value, and beam indices therebetween as the optimal beam index in the elevation direction based on the calculated DSR value and the plurality of elevation reference values.

16. The transmitter of claim 15, wherein
a section between the beam index having the first RSSI value and the beam index having the second RSSI value is divided into a plurality of regions based on the plurality of elevation reference values, and
the controller compares the calculated DSR value with the plurality of elevation reference values to identify a region to which the calculated DSR value belongs; and selects a beam index corresponding to the identified region as the optimal beam index in the elevation direction.

17. The transmitter of claim 11, wherein the controller identifies a first elevation reference value and a second elevation reference value among the precalculated elevation reference values based on a beam index having the first RSSI value and a beam index having the second RSSI value and selects one beam index among the beam index having the first RSSI value, the beam index having the second RSSI value, and beam indices therebetween as the optimal beam index in the elevation direction based on the calculated DSR value, the first elevation reference value, and the second elevation reference value.

18. The transmitter of claim 17, wherein
a section between the beam index having the first RSSI value and the beam index having the second RSSI value is divided into three regions based on the first elevation reference value and the second elevation reference value, and
the controller compares the calculated DSR value with the first elevation reference value and the second elevation reference value to identify a region to which the calculated DSR value belongs; and selects a beam index corresponding to the identified region as the optimal beam index in the elevation direction.

19. The transmitter of claim 11, wherein the power transmitting unit transmits beam scheduling information to the receiver.

20. A method for performing codebook-based beamforming in a wireless charging system, comprising:
calculating an azimuth reference value;
calculating an elevation reference value;
detecting an optimal beam index in an azimuth direction based on the calculated azimuth reference value; and
detecting an optimal beam index in an elevation direction based on the calculated elevation reference value and the detected optimal beam index in the azimuth direction.
